(19) United States
(12) Patent Application Publication
(10) Pub. No.: US 2003/0117610 A1
(43) Pub. Date: Jun. 26, 2003

(54) Film holder

(75) Inventor: Yuichi Kurosawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/309,137

(22) Filed: Dec. 4, 2002

(30) Foreign Application Priority Data
Dec. 6, 2001 (JP) P2001-372329

(51) Int. Cl. G03B 27/04

(52) U.S. Cl. 355/123

(57) ABSTRACT

A film holder comprises a base member and a film pressing member, between which a film is sandwiched. The film is placed on the base member. The film pressing member has a spring portion and a contact portion. When the film pressing member is closed while a film is on the base member, the contact portion comes into contact with a surface of the film and the spring portion is elastically deformed, causing the film to be tensioned outward and to change from a curved condition to a flat condition. Thus, the film is sandwiched between the base member and the film pressing member in a flat condition, so that an image developed on the film can be sensed or read with high accuracy.

### BACKGROUND OF THE INVENTION

1. Field of the Invention

The present invention relates to a film scanner which senses an image developed on a silver halide film, so as to convert the image to an image signal, and more particularly, relates to a film holder which holds the film and which is mounted in the film scanner.

2. Description of the Related Art

Conventionally, there is known a film scanner which reads an image recorded or developed on a photographic film such as a silver halide film, and stores the image as data. A film holder, in which a 35-mm film or a Brownie film containing a predetermined number of frames is held, is mounted in the film scanner, and the film is illuminated by a light source. Thus, the illuminated image is formed on an imaging device such as a CCD line sensor through a photographic lens, and the film is moved in a direction perpendicular to the longitudinal direction of the CCD line sensor, so that the image is sensed.

The film holder has a base member and a film pressing member, that is rotatably supported by the base member so that the film is sandwiched by the base member and the film pressing member.

A silver halide film has a structure whereby photographic emulsion is applied on a resin base made of polyester resin and the like. Therefore, the sectional shape of the surface of the resin base member of a silver halide film when viewed from the longitudinal direction, is convex. Accordingly, when the film is sandwiched by the base member and the film pressing member, the curved shape of the film cannot be restrained, since the base member and the film pressing member support only outer peripheral portions of the film. Thus, the film is not fully made flat, so that it is difficult for the whole plane of the image on the film to be in focus in the imaging device, which makes it difficult to obtain a clear image.

To solve such a problem, it is possible to increase the f-number of the photographic lens so as to increase the depth of focus. However, because of this design change, the photographic lens becomes dark, and thus the accumulating period of the imaging device is increased, so that the scanning speed of the imaging device becomes slow, hence the scanning time becomes longer. On the other hand, it has been proposed that glass such as anti-Newton's glass should cover the whole surface of the film in order to prevent the curve of the film. However, if the reading accuracy of the imaging device is high such as 4000 DPI, for example, a pattern formed by the glass when in contact with the photographic emulsion, or a scratch on the glass, can be read by the imaging device. This causes noise in the image, and thus the S/N ratio decreases.

### SUMMARY OF THE INVENTION

Therefore, an object of the present invention is to provide a film holder, which prevents curvature of a film, so that an image can be accurately focused on an imaging device to read a high-quality image.

According to the present invention, there is provided a film holder for holding a film on which an image is developed, so that the image can be read by an imaging device. The film holder comprises a base member, a film pressing member, and elastic members.

The film is placed on the base member. The film pressing member operates with the base member to sandwich the film. The elastic members come into contact with the film, sandwiched by the base member and the film pressing member, to tension the film outward.

### BRIEF DESCRIPTION OF THE DRAWINGS

The objects and advantages of the present invention will be better understood from the following description, with reference to the accompanying drawings in which:

FIG. 1 is a perspective view in which a film holder of an embodiment of the present invention is disassembled from a film scanner;

FIG. 2 is a side view in which the film scanner is viewed along the direction shown by an arrow A in FIG. 1;

FIG. 3 is a perspective view showing a state in which a film pressing member opens;

FIG. 4 is a sectional view along line B-B shown in FIG 1;

FIG. 5 is an enlarged view of a portion C shown in FIG. 4;

FIG. 6 is an enlarged perspective view of elastic members provided on an inner surface of the film pressing member;

FIG. 7 is an electric circuit diagram of the film scanner;

FIG. 8 is an enlarged sectional view of an elastic member;

FIG. 9 is a flowchart of an image reading operation; and

FIG. 10 is a flowchart of an image scanning process executed in Step S117 shown in FIG. 9.

### DESCRIPTION OF THE PREFERRED EMBODIMENTS

The present invention will be described below with reference to the embodiments shown in the drawings.

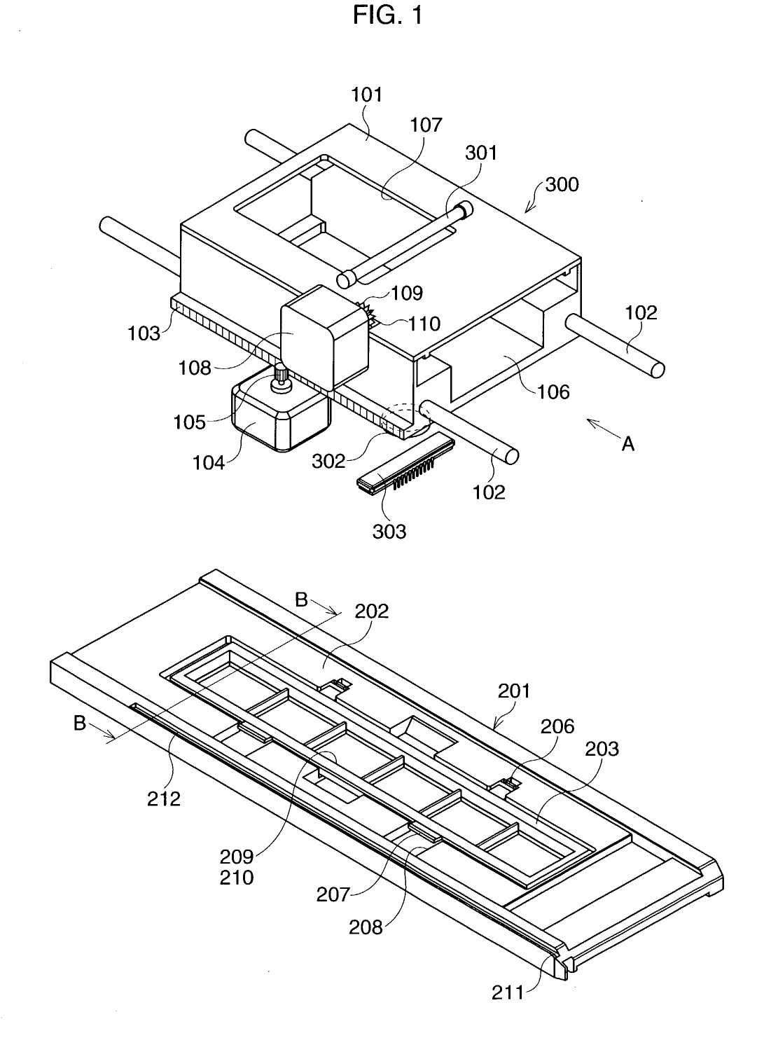

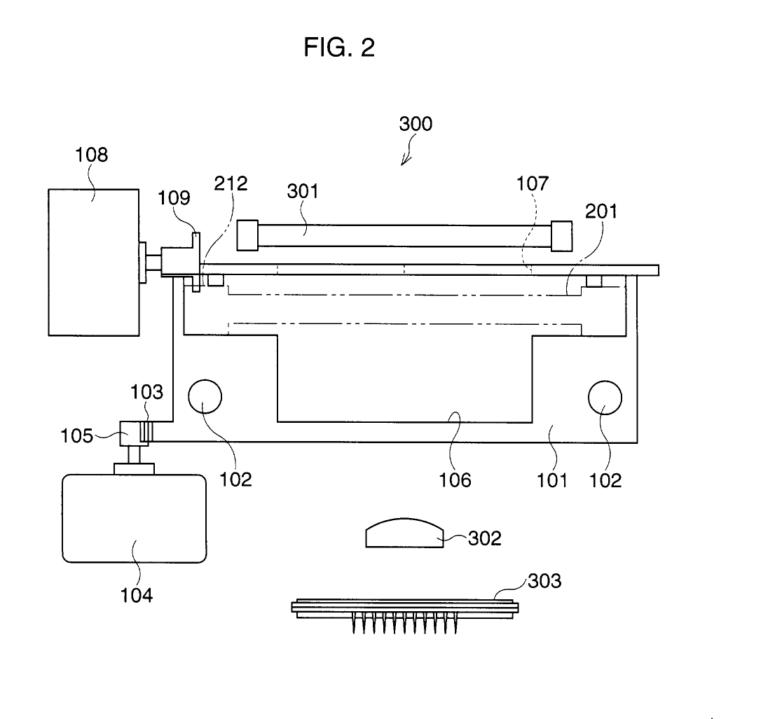

FIG. 1 is a perspective view in which a film holder 201 is disassembled from a film scanner. FIG. 2 is a side view in which the film scanner is viewed along the direction shown by an arrow A in FIG. 1.

Two guide bars 102, extending in a horizontal direction, are mounted in a housing, not shown, of the film scanner. A movable table 101 is supported by the guide bars 102 to move forward and backward along the guide bars 102. A rack 103 is formed on a side surface of the movable table 101. A scan motor 104 is fixed to the housing, and a pinion 105 attached to the rotational shaft of the scan motor 104 is meshed with the rack 103, so that the movable table 101 advances and retreats in accordance with the operation of the scan motor 104.

A holder support groove 106 is formed in the movable table 101, and extends over the whole length of the movable table 101. The film holder 201, in which a film to be read is held, is mounted in the holder support groove 106. A rectangular window 107 is formed in the movable table 101, so that images formed on the film held in the film holder 201 can be exposed through the window 107.

A feed motor 108 is fixed on a side surface of the movable table 101, and a pinion 109 attached to the rotational shaft of the feed motor 108 is disposed in a pinion window 110 formed in the upper wall of the movable table 101, so that the pinion 109 is meshed with a rack 212 formed on a groove 211 of the film holder 201. The scan motor 104 and the feed motor 108 are step motors, which are rotated by a predetermined angle when a pulse signal is input thereto.

A reading unit 300 is disposed in the movable table 101. The reading unit 300 has a diffusing light source 301 located above the guide bars 102, a photographic lens 302 disposed under the guide bars 102 and directly beneath the diffusing light source 301; and a line sensor 303 for photo-converting an image formed through the photographing lens 302. The diffusing light source 301 is a fluorescent lamp radiating white light. The line sensor 303 has a predetermined number of photodiodes aligned on a line with a predetermined pitch. The line is perpendicular to a moving direction of the movable table 101, i.e., perpendicular to the longitudinal direction of the guide bars 102.

In the embodiment, the film holder 201 is provided for holding a 35-mm film that has been cut into strips containing six frames. The film holder 201 has a base member 202, on which the film strip is placed, and a film pressing member 203, which is hinged to the base member 201 to sandwich the film strip between the pressing member 203 and the base member 201. The groove 211, extending in the longitudinal direction of the base member 202, is formed along a longitudinal periphery of the base member 201, and the rack 212 is integrally formed on a bottom surface of the groove 211. The pinion 109 of the feed motor 108 supported by the movable table 101 is meshed with the rack 212.

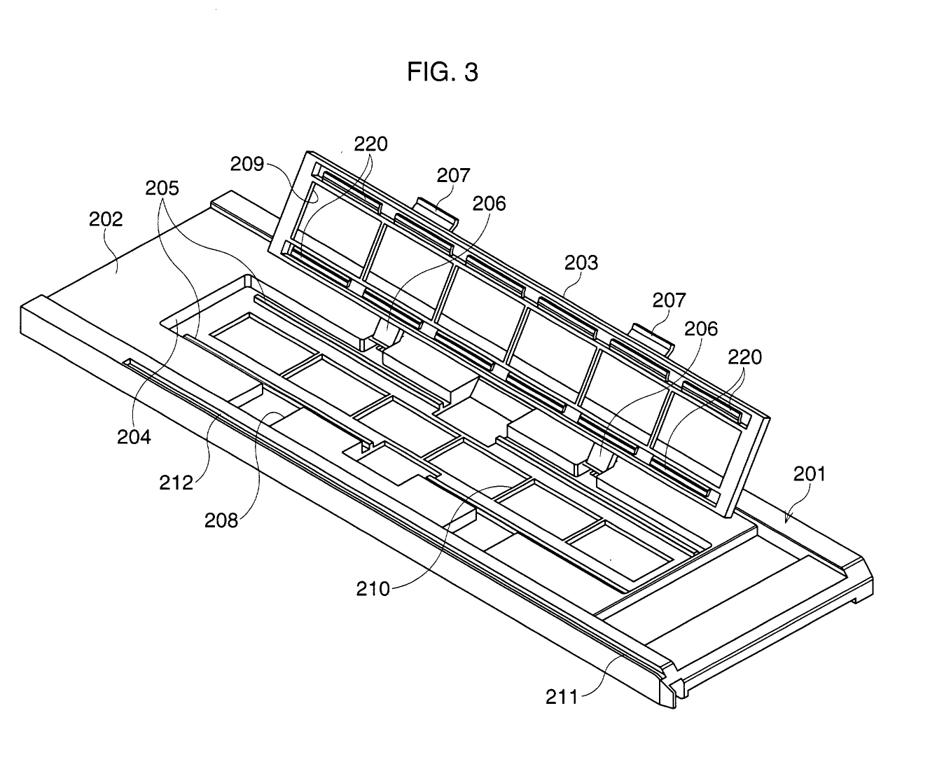

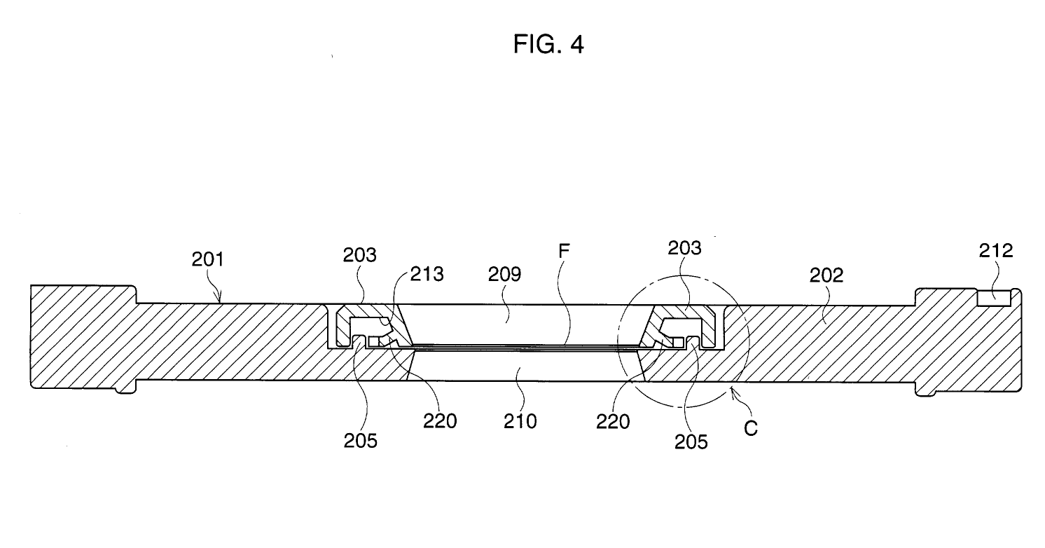

FIG. 3 shows a state in which the film pressing member 203 is open, and FIG. 4 is a sectional view along line B-B shown in FIG. 1.

The base member 202 is provided with a film receiving recess 204, which is rectangular and shallow, to receive the film strip F. The size and the shape of the film pressing member 203 are set in such a manner that the film pressing member 203 fits in the film receiving recess 204. The film pressing member 203 is rotatable about a pair of hinges 206, which are provided on an edge portion of the film pressing member 203, to enable the film pressing member 203 to open and close. Claws 207, provided on the other side to the hinges 206 of the film pressing member 203, are engaged with fit grooves 208 formed in the base member 202 on the side opposite to the hinges 206 of the film receiving recess 204, so that the other side of the film pressing member 203 is fixed to the base member 202.

Six windows 209, having shapes and sizes corresponding to the frames of the film strip, are formed in the film pressing member 203, and are arranged in the longitudinal direction of the film strip, and six windows 210, having shapes and sizes corresponding to the frames of the film strip, are formed in the film receiving recess 204 of the base member 202, and are arranged in the longitudinal direction of the film strip. A pair of guide rails 205, supporting both sides of the film strip along the windows 209 and 210, are provided on a bottom surface of the film receiving recess 204. The film strip is placed between the guide rails 205.

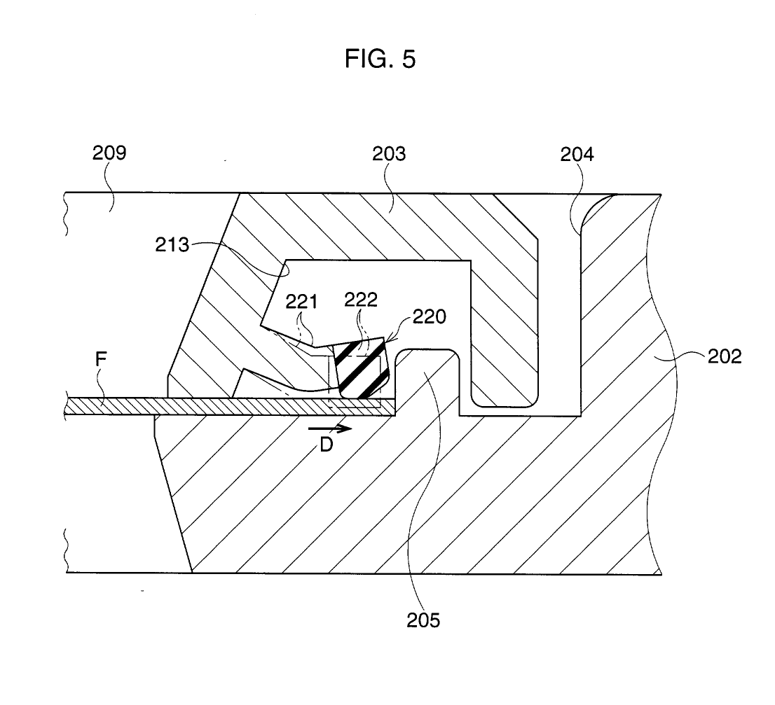

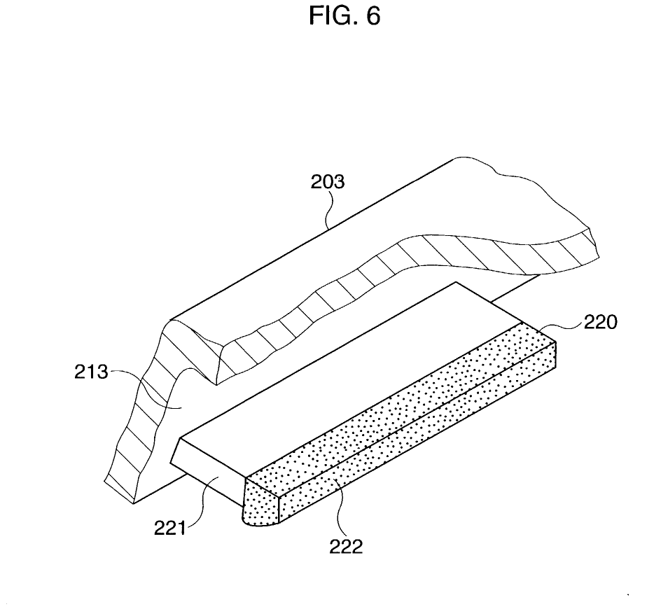

FIG. 5 is an enlarged view of a portion C shown in FIG. 4, and FIG. 6 is an enlarged perspective view of the elastic members 220 provided on an inner surface of the film pressing member 203. The elastic members 220 are provided on support portions of the film pressing member 203, which are located outside each of the windows; that is to say they are provided on both the longitudinal support portions for the film strip F. The film pressing member 203 has pressing grooves 213 on the inner surface thereof. The pressing grooves 213 are provided on both sides of the window 209, and are extended along the longitudinal direction of the film holder. The elastic members 220 are provided in the pressing groove 213 for each of the windows 209.

The elastic member 220 has a spring portion 221 and a contact portion 222. The spring portion 221 has a base end connected to the pressing groove 213 and a tip portion directed toward an outer periphery of the film strip F. The spring portion 221 is a thin plate spring which can be elastically deformed in the thickness direction. The contact portion 222 is provided on the tip portion and the bottom surface of the contact portion 222 is projected lower than the spring portion 221 to come into frictional contact with the film strip F.

The spring portion 221 is integrally formed on the film pressing member 203, the film pressing member 203 and the spring portion 221 being formed of synthetic resin. The contact portion 222 is formed of material, such as soft resin or rubber, which is soft and frictional, and is integrated on the tip portion of the spring portion 221, through adhesion or the like.

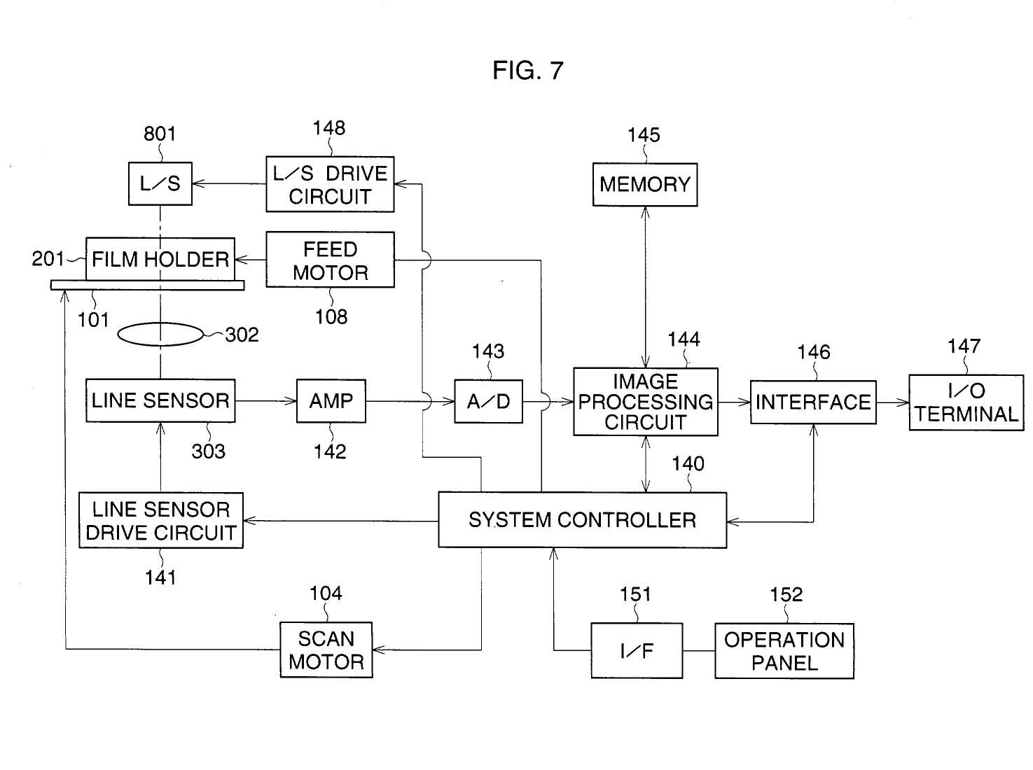

FIG. 7 shows an electric circuit diagram of the film scanner. Note that, in FIG. 7, the components also shown in FIGS. 1-3 are indicated by the same references as in FIGS. 1-3.

The line sensor 303 is operated by a line sensor drive circuit 141 controlled by a system controller 140. A signal, read from the film, is output from the line sensor 303, and is amplified by an amplifier 142. The signal is then converted into a digital signal by an A/D converter 143, and is subjected to a predetermined image process by an image processing circuit 144, so that an image signal is generated. A memory 145 is provided for recording the image signal, and is an IC-card, for example. The image signal is output to an input-output terminal 147 through an interface circuit 146, so that the image signal can be transmitted to a personal computer not shown.

The diffusion light source 301 is controlled to turn ON and OFF, by a light source drive circuit 148 controlled by the system controller 140. The scan motor 104 and the feed motor 108 are controlled by the system controller 140 to rotate, so that the movable table 101 is moved, and the film holder 201 is fed.

An operation panel 152 is provided for operating the film scanner. The operation panel 152 is connected to the system controller 140 through an interface circuit 151.

A scanning operation of the film scanner is described below. First, the film strip F is mounted in the film holder 201. Namely, the claws 207 are disengaged from the fit grooves 208 of the base member 202, and the film pressing member 203 is rotated about the hinges 206 to open, as shown in FIG. 3. The film strip F is then placed between the guide rails 205 in the film receiving recess 204, so that the width direction of the film strip F is positioned. The longitudinal direction of the film strip F is positioned by using both end portions of the film receiving recess 204.

In the film receiving recess 204, the film strip F is placed in such a manner that the photographic emulsion surface faces downward and the resin base member faces upward. Therefore, the film strip F is convex upward, and is curved over the width direction. The film pressing member 203 is rotated so as to cover the film receiving recess 204, and the claws 207 are engaged with the fit grooves 208, so that the film pressing member 203 is fixed on the base member 202. Thus, as shown in FIGS. 4 and 5, the film strip F is sandwiched by the base member 202 and the film pressing member 203 in the film receiving recess 204, so that each of the images on the film strip F is exposed through the windows 209 and 210.

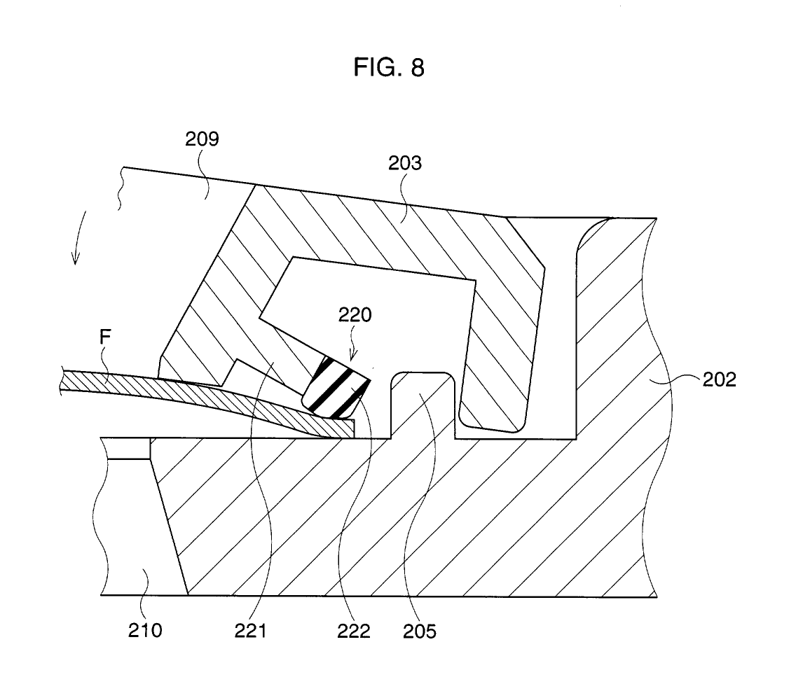

With reference to FIG. 8, the operation of the film pressing member 203 is described below in detail. When the film pressing member 203 is closed, first, the contact portion 222 of the elastic member 220 comes into contact with an upper surface of the resin base member of the film strip F which is curved. Then, when the film pressing member 203 is further closed, the state is changed to that shown in FIG. 5. Namely, a further movement of the contact portion 222 is prevented, and thus the end portion of the spring portion 221 is elastically deformed upward. Due to the elastic restoring force of the spring portion 221, the contact portion 222 applies a force directed outward (arrow D indicated in FIG. 5) to the film strip F while the contact portion 222 is in a frictional contact with the upper surface of the resin base member. Accordingly, the film strip F is tensioned in the width direction by the elastic member 220 along both edges of the film strip F, so that the film strip F is changed from the curved condition to the flat condition.

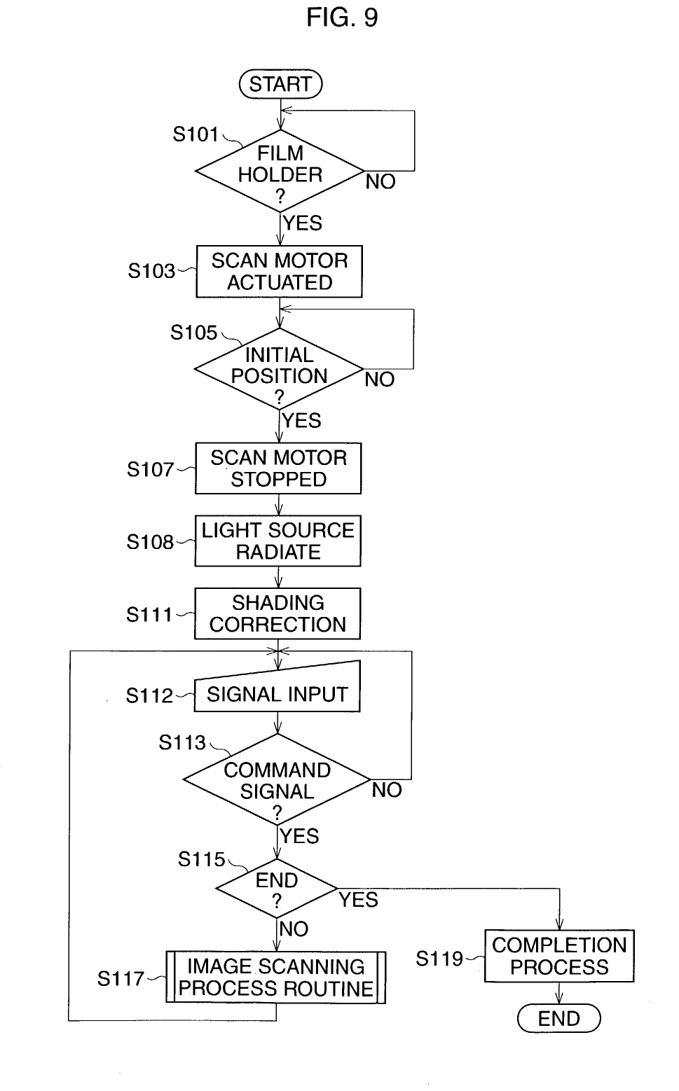

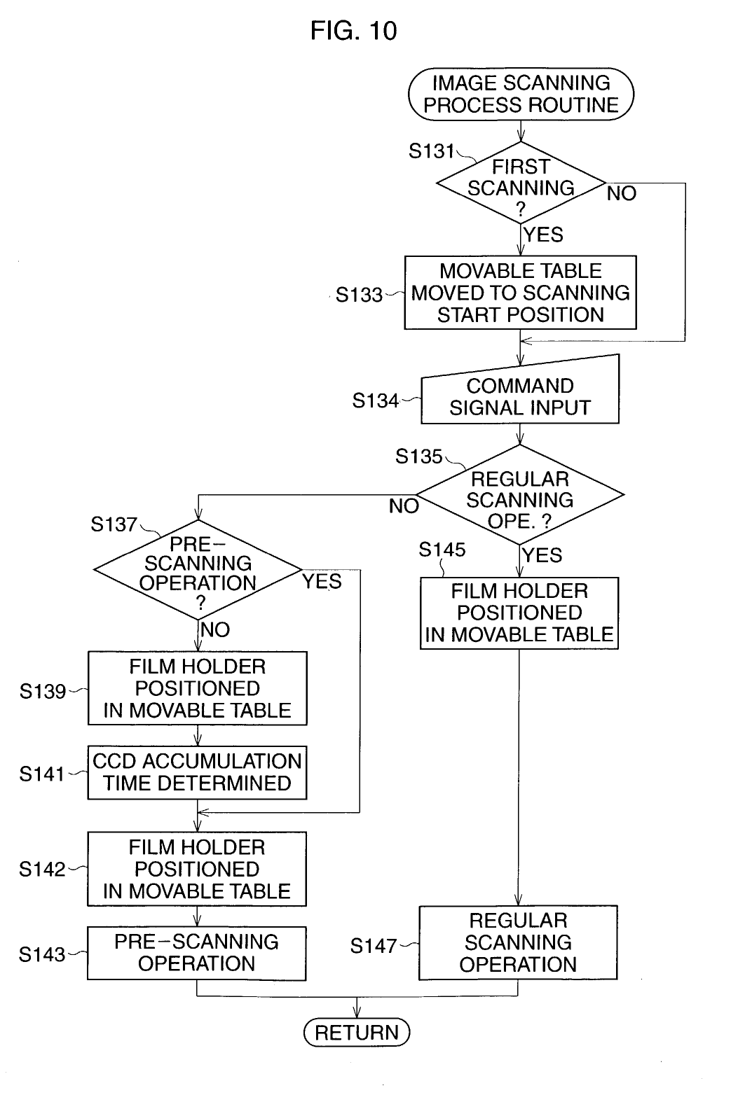

The film holder 201, holding the film strip F as described above, is inserted into the holder support groove 106 of the movable table 101, and is fixed at a predetermined position. The feed motor 108 may be used for the inserting operation of the film holder 201. Thus, an image reading operation is performed in accordance with the flowcharts shown in FIGS. 9 and 10.

FIG. 9 shows a flowchart of an image reading operation. In a state in which the film holder 201 is set in the movable table 101, the front edge of the film holder 201 is located at an edge of the window 107 of the movable table 101. When it is confirmed in Step S101 that the film holder 201 has been inserted in the movable table 101, Step S103 is executed, in which the scan motor 104 is actuated. Then, when it is confirmed in Step S105 that the movable table 101 has been set to an initial position, Step S107 is executed so that the scan motor 104 is stopped.

Under this condition, in Step S109, electric power is supplied to the diffusion light source 301 to radiate light. Light irradiated from the diffusion light source 301 is condensed by the photographic lens 302, and is received by the line sensor 303. In Step S111, based on the light received by the line sensor 303, a shading correction is carried out by the system controller 140. In Step S112, a signal input through the operation panel 152 is read. In Step S113, it is determined whether any command signal is input, and when no command signal is input, the process goes back to Step S112. When it is determined in Step S113 that a command signal has been input, Step S115 is executed, in which it is determined whether the command signal means that the reading operation is to be ended.

When it is determined that the command signal means the end of the image reading operation, a completion process is executed in Step S119 so that the image reading operation ends. Conversely, when it is determined that the command signal means that the image reading operation should be continued, an image scanning process routine described below is performed in Step S117, and the process then goes back to Step S112. The explanation of the completion process is omitted.

FIG. 10 is a flowchart of the image scanning process routine executed in Step S117. In Step S131, it is determined whether a scanning operation is going to be performed for the first time. When the scanning operation is for the first time, Step S133 is executed, in which the movable table 101 is moved by the scan motor 104 to a first scanning start position, which is at a side opposite to a side from which the film holder 201 is inserted. Note that, when the scanning operation is not for the first time, Step S133 is not executed, since the movable table 101 has been set to the first scanning start position or to a second scanning start position, which is opposite to the first scanning start position with respect to the image to be scanned.

In Step S134, a scanning command signal is input by the operation panel 152. In Step S135, it is determined whether a regular scanning operation is going to be performed, by which the image is sensed with high accuracy, based on the scanning command signal input through the operation panel 152.

When it is determined in Step S135 that a pre-scanning operation is going to be performed, Step S137 is executed, in which it is determined whether the pre-scanning operation has been performed. When the pre-scanning operation has not been performed, Step S139 is executed, in which the feed motor 108 is actuated to move the film holder 201 in the holder support groove 106 of the movable table 101, so that the film holder 201 is set to a predetermined position. Then, light passing through the film strip F is condensed by the photographing lens 302, so that the line sensor 303 receives the light. In Step S141, based on the amount of the received light, a CCD accumulation time of the photodiodes provided in the line sensor 303 is determined.

Conversely, if the pre-scanning operation has been performed, the CCD accumulation time previously determined in the pre-scanning operation can be used, hence Steps S139 and S141 are not executed.

In Step S142, the film holder 201 is set to a position where the pre-scanning operation is to be started. In Step S143, the scan motor 104 is actuated to move the movable table 101, the image is scanned by the line sensor 303, and some of the pixel data read out from the line sensor 303 are thinned out, so that the pre-scanning operation is carried out to obtain an image having a coarse accuracy.

On the other hand, when it is determined in Step S135 that a regular scanning operation is going to be performed, Step S145 is executed, in which, in a similar way as that in the pre-scanning operation, an image to be sensed is set to a predetermined position relative to the reading unit 300 by the feed motor 108. The regular scanning operation is then carried out in Step S147. At this time, if a pre-scanning operation has been performed, the regular scanning operation is carried out using the CCD accumulation time obtained by the pre-scanning operation. Conversely, if a pre-scanning operation has not been performed, the regular scanning operation is carried out using a standard accumulation time, which is stored beforehand in the film scanner.

In the regular scanning operation, the movable table 101 is moved by driving the scan motor 104, so that the image is sensed by the line sensor 303. And, all the pixel data output from the line sensor 303 is used, so that the image is sensed with a high accuracy.

After the pre-scanning operation and the regular scanning operation are completed in the image scanning process routine, the process goes back to Step S112 of FIG. 9. Note that, as described above, when a scanning operation has been performed once, the movable table 101 has been moved to the rear of the image. Therefore, in the next scanning operation, the movable table 101 is moved in the reverse direction to that of the previous scanning operation. However, it is possible to return the movable table 101 to the initial scanning position after every scanning operation so that it is always moved in the same direction for each scanning operation.

Thus, in the pre-scanning operation and the regular scanning operation, the film strip F sandwiched by the film holder 201 is kept flat due to the operation of the elastic members 220. Therefore, the whole image is scanned by the line sensor 303 in an in-focus condition, so that the image is sensed or read with a high accuracy to obtain a high quality image.

If the elastic members 220 and the spring portion 221 are made of resin and formed by molding, it is usual to use insert molds which are parted in different directions when releasing from the set resin. Conversely, if the pressing groove 213 formed in the film pressing member 203 is formed to be continuous and open at the both ends along the longitudinal direction of the film pressing member 203, the spring portion 221 is easily molded, using a slider mold.

Although, in the embodiment, the film holder is provided for supporting a film strip obtained by cutting a 35-mm film, the present invention can be applied to a film holder for a Brownie film or a sheet film. Further, although, in the embodiment, the elastic members 220 are provided on portions corresponding to each of the windows, the elastic members 220 can be provided on arbitral portions, independently of the dispositions of the windows.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2001-372329 (filed on Dec. 6, 2001) which is expressly incorporated herein, by reference, in its entirety.

1. A film holder for holding a film on which an image is developed, so that said image is read by an imaging device, said film holder comprising:
a base member on which said film is placed;
a film pressing member that operates with said base member to sandwich said film; and
elastic members that come into contact with said film, sandwiched by said base member and said film pressing member, to tension said film outward.

2. A film holder according to claim 1, wherein said elastic members are provided on a pressing surface of said film pressing member, said pressing surface facing said base member.

3. A film holder according to claim 1, wherein each of said elastic members comprises a spring portion, which has a base end connected to said film pressing member and a tip portion directed toward an outer periphery of said film, and a contact portion, which is provided on said tip portion and comes into frictional contact with said film.

4. A film holder according to claim 3, wherein said spring portion is integrally formed on said film pressing member, said film pressing member and said spring portion being formed of synthetic resin.

5. A film holder according to claim 3, wherein said contact portion is formed of rubber, and integrated on said tip portion.

6. A film holder according to claim 1, wherein each of said base member and said film pressing member is provided with a window, through which said film is exposed, and said elastic members are provided on support portions of said film pressing member, said support portions being located outside said window, and lying on both sides of said pressing member in a longitudinal direction.
